(19) United States
(12) Patent Application Publication
(10) Pub. No.: US 2014/0215516 A1
(43) Pub. Date: Jul. 31, 2014

(54) INFORMATION PROCESSING DEVICE, METHOD FOR CONTROLLING INFORMATION PROCESSING DEVICE, CONTROL PROGRAM, AND RECORDING MEDIUM

(71) Applicant: Masafumi Yashiki, Osaka-shi (JP)

(72) Inventor: Masafumi Yashiki, Osaka-shi (JP)

(73) Assignee: SHARP KABUSHIKI KAISHA, Osaka-shi, Osaka (JP)

(21) Appl. No.: 14/241,587

(22) PCT Filed: Jun. 20, 2012
(86) PCT No.: PCT/JP2012/065786

§ 371 Date: Feb. 27, 2014

(30) Foreign Application Priority Data
Sep. 7, 2011 (JP) 2011-195279

(51) Int. Cl. H04N 21/482; H04N 21/462

(52) U.S. Cl. CPC H04N 21/482; H04N 21/462
USPC 725/39

(57) ABSTRACT

An information processing device includes a content identification information selecting section that allows a user to select at least a single piece of content identification information from content identification information, a registered information storing section that associates the selected content identification information with user operation, one to one, and stores the associated content identification information and user operation, and a registered information output section that, when the user operation is received, outputs content identification information stored in the storage section in association with the user operation to an external destination.

### TECHNICAL FIELD

The present invention relates to an information processing device and the like that output content identification information including information that identifies content.

### BACKGROUND ART

An electronic program guide (EPG) is a system for displaying, on a device such as a television receiver that outputs content received from an external source to a display section, information related to the content. The information is carried by being superimposed onto digital broadcast waves of each broadcast station. Therefore, the information is delivered to a user in real-time. In recent years, televisions, recorders, and the like have become popular that allow the user to select desired content from a content table generated using EPG, thereby enabling the content to be displayed and recording instructions for the content to be given.

As the number of broadcast stations increases and the amount of content being provided increases, for example, by sub-channels becoming widely used with the start of digital broadcasting, the above-described content table becomes significantly large. All of the information included in the content table can be displayed at once, if each piece of information is displayed in a small size. However, because of deterioration of viewability and the limitations of screen resolution, there is a limit to reduced display. Therefore, in general, the user operates an input device, such as a remote control, and displays a section of the content table corresponding to a desired broadcast station or time slot.

However, when the content table becomes even larger, the above-described operation for designating the position to be partially displayed becomes very complicated. For example, in an instance in which the user is viewing content being broadcast by a certain broadcast station and wishes to check, on the same screen, a different content (referred to, hereinafter, as a “counter-content”) being broadcast from another broadcast station in the same time slot, operations (such as scrolling the page and moving the cursor) required for changing the partial display increases as the number of broadcast stations increases. Therefore, it becomes difficult to quickly list counter-contents and display the desired content.

In addition, in digital broadcasting, when each broadcast station provides a plurality of contents as sub-channels, content being broadcast on a sub-channel cannot be selected by a single-step operation using, for example, a typical television remote control. In other words, when a key (such as a button from 1 to 12) for selecting a broadcast station is pressed, the content being broadcast on a main channel is selected. Therefore, to select the content being broadcast on the sub-channel, a complicated operation may be required, such as pressing the key in combination with another key.

The above-described issue will be described in detail with reference to FIG. 12. FIG. 12 illustrates an example of a television screen typically expressing the above-described issue. The user is displaying the content table while viewing content. However, to check information outside of the section of the content table being displayed on the screen, the user is required to scroll the content table in a vertical (time) direction or a horizontal (broadcast station) direction.

To solve this issue, a technology has been developed in which the user registers a desired broadcast station in advance and only information of the registered broadcast station is displayed. For example, in PTL 1, below, a display device is disclosed that is capable of switching display between a registered electronic program table and an electronic program table including a plurality of service names and displaying the program table.

In addition, a technology has also been developed in which contents that have already been viewed are registered and displayed so that the user can make a selection from a list of the registered contents. For example, PTL 2, below, discloses a program selecting method that allows a desired program to be easily identified when the user successively selects and views videos of programs.

### CITATION LIST

### Patent Literature

PTL 1: Japanese Unexamined Patent Application Publication No. 2006-217501 (published Aug. 17, 2006)
PTL 2: Japanese Unexamined Patent Application Publication No. 2008-67403 (published Mar. 21, 2008)

### SUMMARY OF INVENTION

### Technical Problem

However, the above-described display device disclosed in PTL 1 performs registration in units of broadcast stations, and not in unites of contents. In other words, the display device is based on a technology for designating in advance a broadcast station often viewed by the user, and separately creating a content table only for the broadcast station. The display device is not based on a technology for registering desired contents across broadcast stations. In digital broadcasting in particular, it is typical for numerous broadcast stations to provide a plurality of contents as sub-channels. Therefore, it is difficult to view all the information related to contents easily by merely reconfiguring the content table in units of broadcast stations. It is desirable that only information truly required by the user is listed by presenting the information in units of contents.

In addition, in the above-described display device disclosed in PTL 1, an operation involving a plurality of steps such as presenting the broadcast station including the desired content and selecting and displaying the content is required. Therefore, the above-described display device is not suitable for so-called zapping in which broadcast stations are switched one after another and counter-contents are searched. In the broadcasting environment of recent years in which the number of broadcast stations has increased and an extremely large number of contents are provided at once, it is preferable that the desired content, such as counter-content, can be selected with a single step.

On the other hand, in the above-described program selecting method disclosed in PTL 2, registration is performed in units of contents. However, registration is limited to contents that have been viewed by the user. In other words, a condition for registration is that the user has selected the content. The purpose of the program selecting method is not to allow the user to easily select the desired content. In addition, even when the content is selected after being registered, selecting the content involves page scrolling and cursor moving. Therefore, operational load placed on the user during zapping cannot be reduced.

The present invention has been made in light of the above-described issues, and an object of the present invention is to provide an information processing device and the like that enable a user to register and select desired content by an easy operation.

### Solution to Problem

To solve the above-described problem, the present invention provides an information processing device that is

(1) an information processing device that outputs, in accordance with an operation by a user, content identification information including information that identifies content, the information processing device including:

(2) a selecting means for acquiring the content identification information from an external source, and allowing the user to select at least a single piece of content identification information from the content identification information;

(3) a storing means for associating the content identification information selected by the selecting means with the operation by the user, one to one, and storing the associated content identification information and operation by the user in a storage section; and

(4) an output means for outputting, when the operation by the user is received, content identification information stored in the storage section in association with the received operation to an external destination.

In addition, to solve the above-described problem, the present invention provides a method for controlling an information processing device that is

(1) a method for controlling an information processing device that outputs, in accordance with an operation by a user, content identification information including information that identifies content, the method including:

(2) a selecting step of acquiring the content identification information from an external source, and allowing the user to select at least a single piece of content identification information from the content identification information;

(3) a storing step of associating the content identification information selected at the selecting step with the operation by the user, one to one, and storing the associated content identification information and operation by the user in a storage section; and

(4) an output step of outputting, when the operation by the user is received, content identification information stored in the storage section in association with the received operation to an external destination.

According to the above-described configuration, the information processing device and the method for controlling the information processing device receive registration of content from the user in units of contents by associating the content identification information selected by the user with a predetermined operation, one to one, and storing the associated content identification information and operation in the storage section. At this time, because association between the content and the predetermined operation is automatically performed, registration of content does not require a complicated operation.

In addition, when the operation by the user is received, the information processing device determines the content identification information stored in association with the operation and outputs the content identification information to an external destination. Therefore, even when numerous contents are provided, the user can quickly select the desired content from the contents registered by the user. Therefore, operation load during zapping can be reduced.

The information processing device may be realized by a computer. In this instance, a control program that allows the information processing device to be realized by a computer by enabling the computer to operate as each function of the information processing device and a computer-readable recording medium storing therein the control program are included in the scope of the present invention.

### Advantageous Effects of Invention

As described above, the information processing device of the present invention is an information processing device that outputs, in accordance with an operation by a user, content identification information including information that identifies content. The information processing device includes: a selecting means for acquiring the content identification information from an external source, and allowing the user to select at least a single piece of content identification information from the content identification information; a storing means for associating the content identification information selected by the selecting means with the operation by the user, one to one, and storing the associated content identification information and operation by the user in a storage section; and an output means for outputting, when the operation by the user is received, content identification information stored in the storage section in association with the received operation to an external destination.

In addition, the method for controlling an information processing device of the present invention is a method for controlling an information processing device that outputs, in accordance with an operation by a user, content identification information including information that identifies content. The method includes: a selecting step of acquiring the content identification information from an external source, and allowing the user to select at least a single piece of content identification information from the content identification information; a storing step of associating the content identification information selected at the selecting step with the operation by the user, one to one, and storing the associated content identification information and operation by the user in a storage section; and an output step of outputting, when the operation by the user is received, content identification information stored in the storage section in association with the received operation to an external destination.

Therefore, when registration of content is received from the user in units of contents, association between each content and a predetermined operation is automatically performed. Therefore, an effect is achieved in which registration of content does not require a complicated operation.

In addition, even when numerous contents are provided, the user can quickly select the desired content from contents registered by the user. Therefore, an effect can be achieved in which operation load during zapping can be reduced.

### BRIEF DESCRIPTION OF DRAWINGS

FIG. 1 is a block diagram illustrating a configuration of main sections of a display device including therein an information processing device according to an embodiment of the present invention.

FIG. 2 is a schematic diagram illustrating an example of an input device used by a user to perform input into the display device illustrated in FIG. 1.

FIG. 3 is a schematic diagram illustrating an example of a screen that is displayed when the user presses a key on a remote control in a state in which a content table is being displayed in the display device illustrated in FIG. 1, in which (a) illustrates a screen that is displayed before the key on the remote control is pressed and (b) illustrates a screen that is displayed after the key is pressed.

FIG. 4 is a schematic diagram illustrating an example of a screen that is displayed when the user presses a key on the remote control in a state in which content is being displayed in the display device illustrated in FIG. 1, in which (a) illustrates a screen that is displayed when the key on the remote control is pressed and (b) illustrates a screen that is displayed after user operation is performed.

FIG. 5 is a conceptual diagram illustrating, in a table format, details included in registered information.

FIG. 6 is a schematic diagram illustrating examples of a display format of a registered content table in which (a) illustrates an example in which the registered content table is structured in a format in which the registered information is vertically arrayed, (b) illustrates an example in which the registered content table is structured in a format in which the registered information is horizontally arrayed, and (c) illustrates an example in which the registered content table illustrated in above-described (a) is displayed in an enlarged state.

FIG. 7 is a flowchart describing an example of a process performed by the display device illustrated in FIG. 1 when the user presses a register button on the remote control in an instance in which the content table is being displayed.

FIG. 8 is a flowchart describing an example of a process performed by the display device illustrated in FIG. 1 when the user presses a registered content table button on the remote control in an instance in which content is being viewed.

FIG. 9 is a block diagram illustrating a configuration of main sections of a display device including therein an information processing device according to another embodiment of the present invention.

FIG. 10 is a flowchart describing an example of a process performed by the display device illustrated in FIG. 9 when the user presses a registered content table button on the remote control in an instance in which content is being viewed.

FIG. 11 is a block diagram illustrating a configuration of main sections of a display device providing functions equivalent to the information processing device illustrated in FIG. 1 and the information processing device illustrated in FIG. 9.

FIG. 12 is a schematic diagram illustrating an example of a television screen typically expressing an issue in the past that requires a complicated operation.

### DESCRIPTION OF EMBODIMENTS

### First Embodiment

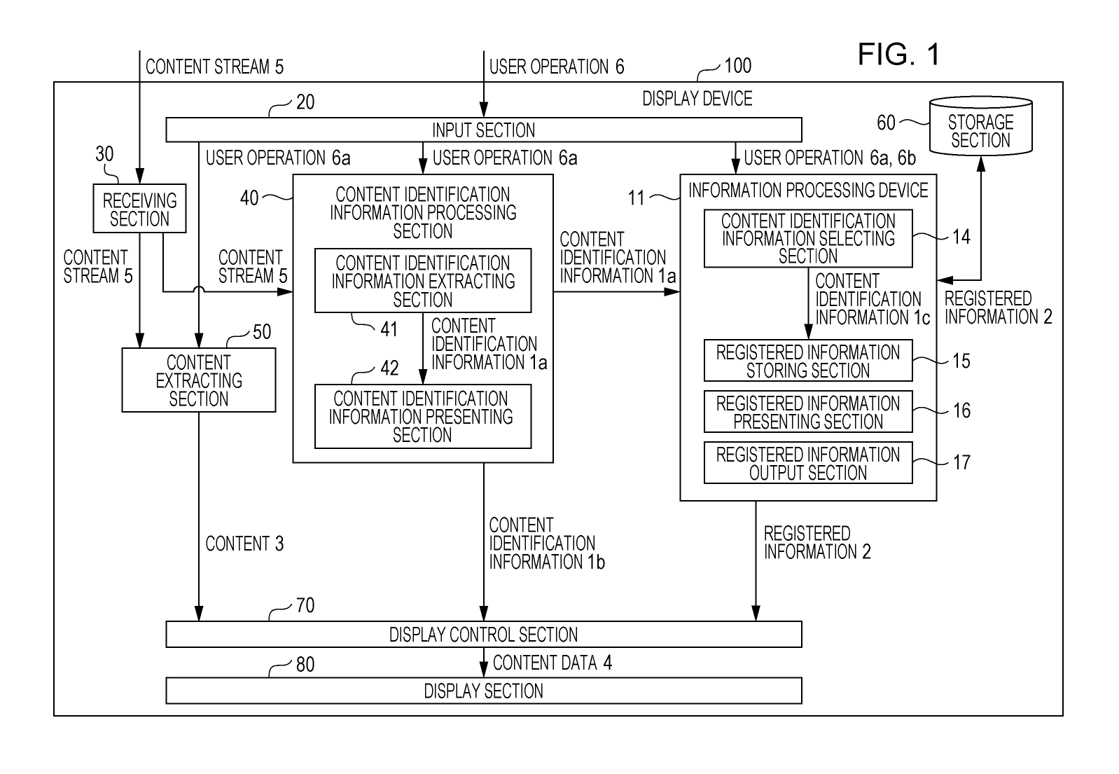

A first embodiment of the present invention will be described in detail with reference to FIG. 1 to FIG. 8. Here, a display device 100 is assumed as a display device that includes therein an information processing device 11. Regarding a configuration that is clearly indicated as being present in a plural number by a, b, or c being attached to a single reference numeral, the configuration may be collectively referred to with a, b, and c being omitted to simplify the description (for example, content identification information 1a, 1b, and 1c may be collectively referred to as “content identification information 1”).

Here, according to the present embodiment, “content” mainly refers to a television program broadcast from a broadcast station (including both main channel and sub-channels). However, the “content” may also be any video, image, music, sound, writing, text, mathematical expression, number, symbol, and the like provided through cable television, CS broadcasting, radio broadcasting, the Internet, and the like.

In addition, “content identification information” is information including information that can identify content. For example, the “content identification information” includes EPG information and various pieces of data acquired over the Internet and the like. Furthermore, “registered information” refers to information associating at least content identification information selected by a user with a predetermined operation by the user. The registered information may also include other additional information. Details of the additional information will be described in detail hereafter.

[Overview of Information Processing Device 11]

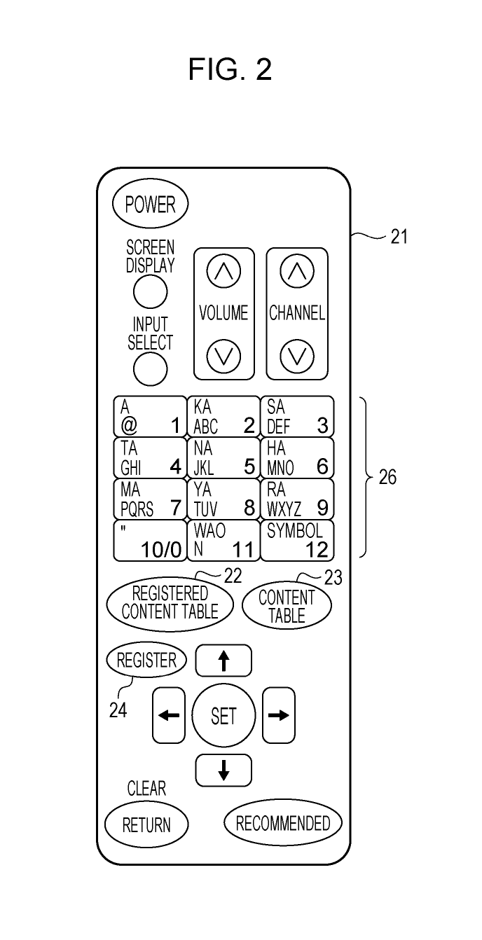

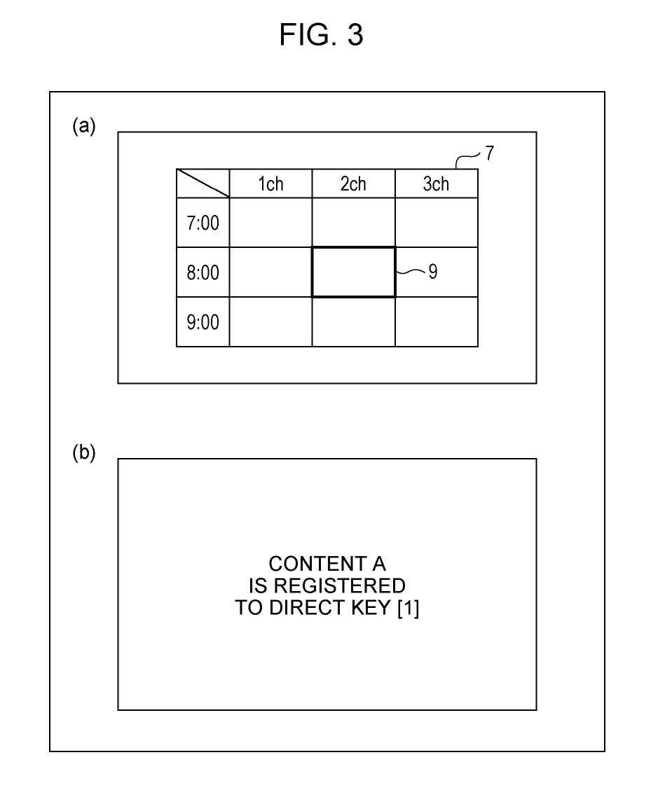

An overview of operations of the information processing device 11 will be described with reference to FIG. 2 and FIG. 3. FIG. 2 is a schematic diagram illustrating an example of an input device used by the user to perform input into the display device 100 (a remote control 21 is illustrated herein as an example). FIG. 3 is a schematic diagram of an example of a screen that is displayed when the user presses a key 24 (“register” button) on the remote control (operable input device) 21 in a state in which a content table 7 is being displayed in the display device 100, in which (a) illustrates a screen that is displayed before the key 24 on the remote control 21 is pressed and (b) illustrates a screen that is displayed after the key 24 is pressed.

The “content table” referred to herein is a table in which the content identification information is arrayed in accordance with a predetermined format. The content table includes, for example, a television program table that is generated using EPG. As the predetermined format, a format can be considered in which the content identification information is associated with a value of a first field (such as broadcast time) and a value of a second field (such as broadcast station), and disposed in a position at which a row showing the value of the first field and a column showing the value of the second field intersect.

When the user presses a key 23 (“content table” button), the content table 7 is displayed as in the display example illustrated in FIG. 3 (a). When the user positions a cursor 9 in an area displaying content identification information 1 that corresponds with a desired content 3 and presses the key 24, the information processing device 11 associates the content identification information with a predetermined operation by the user and stores the associated content identification information and predetermined operation in a storage section 60 as registered information 2.

At this time, as in the display example illustrated in FIG. 3 (b), a display may be performed that gives notification that the content has been registered as the registered information 2 (in FIG. 3 (b), a notification is given that a direct key [1] has been associated with content identification information 1c that corresponds to content A as the predetermined operation by the user).

The operation by the user that is associated during registration is hereinafter referred to as a “user operation 6b”. Other common operations are referred to as a “user operation 6a”. Specific details of the user operation 6b will be described in detail hereafter.

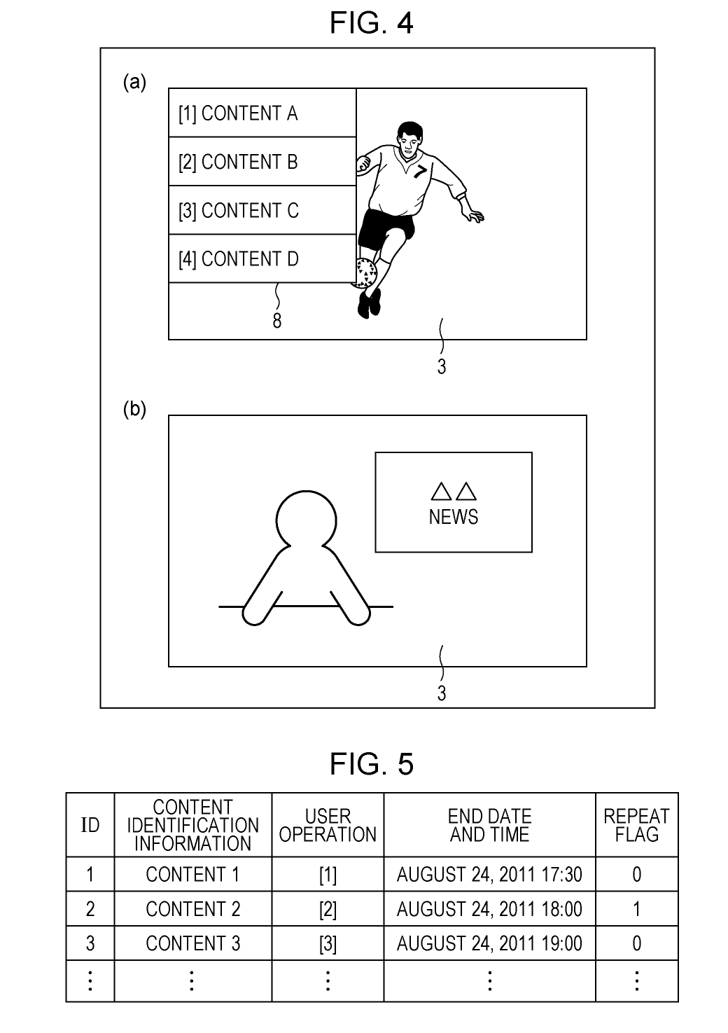

An overview of operations of the display device 100 will further be described with reference to FIG. 4. FIG. 4 is a schematic diagram illustrating an example of a screen that is displayed when the user presses a key 22 (“registered content table” button) of the remote control 21 in a state in which the content 3 is being displayed in the display device 100, in which (a) illustrates a screen that is displayed when the key 22 of the remote control 21 is pressed and (b) illustrates a screen that is displayed after the user operation 6b has been performed.

As described above, when the user presses the key 22 after registering the desired content 3 as the registered information 2, as in the display example illustrated in FIG. 4 (a), a registered content table 8 is displayed. When the user performs the user operation 6b associated in the registered information 2 related to the desired content 3, the content is displayed as in the display example illustrated in FIG. 4 (b).

Here, it should be noted that the above-described user operation is a very simple operation involving only a few steps. As a result, because the user can instantly select the content that has been registered in advance, so-called zapping can be comfortably performed. In addition, the registered content table 8 has less information to be displayed than the content table 7. Therefore, for example, even when the registered content table 8 is displayed such as to be superimposed over the content that is being viewed, viewing is not easily obstructed. In addition, even when the registered content table 8 is displayed in an enlarged state, the registered content table 8 can be viewed on a single screen.

[Configuration of Display Device 100]

A configuration of the display device 100 according to the present embodiment will be described with reference to FIG. 1. FIG. 1 is a block diagram illustrating a configuration of main sections of the display device 100. As illustrated in FIG. 1, the display device 100 includes the information processing device 11, an input section 20, a receiving section 30, a content identification information processing section 40, a content extracting section 50, a storage section 60, a display control section 70, and a display section 80.

The information processing device 11 includes a content identification information selecting section (selecting means) 14, a registered information storing section (storing means) 15, a registered information presenting section (presenting means) 16, and a registered information output section (output means) 17. The content identification information processing section 40 includes a content identification information extracting section 41 and a content identification information presenting section 42.

Sections that are not directly related to the present embodiment (for example, devices such as a speaker that realize audio output, and connection terminals enabling connection to external devices) are omitted from the description of the configuration and the block diagram, in terms of ensuring simplicity of the description. However, the omission of description does not mean that the omitted configurations cannot be included in the configuration according to the present embodiment. In other words, the display device 100 according to the present embodiment may include the omitted configurations in accordance with actual conditions of implementation.

Hereafter, functions provided by each configuration will be described in order regarding the information processing device 11 (content identification information selecting section 14, registered information storing section 15, registered information presenting section 16, and registered information output section 17), the content identification information processing section 40 (content identification information extracting section 41 and content identification information presenting section 42), and other configurations (input section 20, receiving section 30, content extracting section 50, storage section 60, display control section 70, and display section 80).

(Information Processing Device 11)

The information processing device 11 outputs the content identification information 1c to the display device 100, thereby making the display device 100 that has received the content identification information 1c display the content 3 identified by the content identification information 1c. In addition, the information processing device 11 detects the user operation 6 performed by the user via the input section 20.

According to the present embodiment, the information processing device 11 is configured such as to be included within the display device 100. However, the information processing device 11 and the display device 100 may be made capable of communication, and the information processing device 11 may be set outside of the display device 100. In other words, the display device 100 is not required to include the information processing device 11 therein as long as the information processing device 11 is configured to output the content identification information 1c to the display device 100.

The content identification information selecting section 14 acquires content identification information 1a from the content identification information extracting section 41, described hereafter (the content identification information 1a refers to all pieces of content identification information included in a content stream 5 received by the receiving section 30). In addition, the content identification information selecting section 14 allows the user to select at least a single piece of content identification information from the content identification information 1a. In other words, the content identification information selecting section 14 judges whether or not the user operation 6a detected by the information processing device 11 is pressing of a predetermined key (such as the key 24) that is used by the user to select the content identification information. When judged that the key is pressed, the content identification information selecting section 14 outputs the selected content identification information 1c to the registered information storing section 15.

For example, the content identification information selecting section 14 may generate the content table 7 and allow the user to select the content identification information identifying the desired content by operating the cursor 9 or the like. When the user operation 6a (such as pressing the key 24 of the remote control 21) is made by the user, the content identification information selecting section 14 outputs the content identification information 1c selected by the user operation 6a among the content identification information 1a to the registered information storing section 15.

The registered information storing section 15 associates the content identification information 1c inputted from the content identification information selecting section 14 with the user operation 6b and stores the associated content identification information 1c and user operation 6b in the storage section 60 as the registered information 2. Here, the registered information storing section 15 holds all user operations 6b candidates that can be associated with the content identification information 1c. In addition, the registered information storing section 15 increases or decreases the candidates for user operation 6b (in other words, performs assignation and cancels assignations), every time content is registered or deleted.

The registered information presenting section 16 presents to the user the content identification information 1c included in the registered information 2 stored in the storage section 60. In other words, the registered information presenting section 16 judges whether or not the user operation 6a detected by the information processing device 11 is pressing of a predetermined key (such as the key 22) that is used by the user to display the registered content table 8. Then, when judged that the key is pressed, the registered information presenting section 16 reads out the registered information 2 stored in the storage section 60, generates the registered content table 8 from the content identification information 1c included in the registered information 2, and outputs the registered content table 8 to the display control section 70. The registered content table 8 will be described in detail hereafter.

When the registered information output section 17 receives the user operation 6b, the registered information output section 17 outputs, to the display device 100, the content identification information 1c stored in the storage section 60 in association with the user operation 6b.

The display device 100 receives the content identification information 1c outputted from the registered information output section 17 and can thereby determine the content 3 identified by the content identification information 1c.

(Content Identification Information Processing Section 40)

The content identification information processing section 40 processes the content identification information 1a and outputs content identification information 1a or 1b to the information processing device 11 or the display control section 70.

The content identification information extracting section 41 extracts only the content identification information 1a from the content stream 5 received by the receiving section 30, and outputs the content identification information 1a to the information processing device 11 and the content identification information presenting section 42.

The content identification information presenting section 42 outputs, to the display control section 70, the content identification information to be presented to the user among the content identification information 1a related to all contents 3 as the content identification information 1b. Here, the content identification information 1b includes, for example, only the content identification information required to generate the content table 7. The user can change the details of the content identification information 1b by the user operation 6a (operations such as scrolling the content table).

(Other Configurations)

The input section 20 receives the user operation 6. The input section 20 is merely required to be an interface that receives input from the user. For example, common devices that receive input signals from an input interface can be considered, such as buttons, a keyboard, or a mouse provided in the remote control 21 or the display device 100.

The interface used by the user for input might not be a hardware interface including a physical button. For example, the remote control 21 may have a liquid crystal screen including a touch panel. The user may provide the display device 100 with the user operation 6 by pressing a software key displayed on the liquid crystal screen.

The receiving section 30 receives the content stream 5 from an external source. The content stream 5 is any data including the content 3 and the content identification information 1. For example, the content stream 5 may be digital broadcast waves for television.

The content extracting section 50 extracts only the content 3 from the content stream 5 received by the receiving section 30, and outputs the content 3 to the display control section 70. The user can, for example, switch a reception source of the content by the user operation 6a.

The storage section 60 is a non-volatile storage device that stores the registered information 2. The storage section 60 can be configured by, for example, a semiconductor memory, a hard disk, a digital versatile disk (DVD), or the like. According to the present embodiment, the storage section 60 is illustrated in FIG. 1 as a device included within the display device 100. However, the storage section 60 may be realized as an external storage device externally connected to the display device 100. Alternatively, the storage section 60 may be realized as an internal storage device included within the information processing device 11.

The display control section 70 converts the information (such as the content 3 and the content identification information 1) outputted by the display device 100 to content data 4 conforming to a format that can be displayed in the display section 80. Here, the display control section 70 is merely required to be capable of performing format conversion of the information to the content data 4 and may be, for example, a common display adapter.

The display section 80 is a device that displays video and the like. The type of hardware is not limited as long as a function is provided for processing and displaying the content data 4 received as input from the display control section 70. The display section 80 may be configured by, for example, a liquid crystal display, an organic electroluminescence (EL) display, or the like.

[Examples of User Operation 6b]

The user operation 6b associated with the content identification information 1c in the registered information 2 is any operation by the user performed via the input section 20. For example, the operation may be pressing of a key 26 (number buttons from 1 to 12) on the remote control 21. In this instance, the information processing device 11 (registered information storing section 15) associates the content identification information 1c identifying the content 3 selected by the user with any of the 12 types of keys 26, one to one, and then stores the associated content identification information 1c and the key 26 in the storage section 60 as the registered information 2.

As a result, when the information processing device 11 detects that the key 26 has been pressed by the user, the information processing device 11 can output, to the display device 100, the content identification information 1c associated with the pressing of the key 26. Therefore, the display device 100 can display the content 3 identified by the content identification information 1c. Thus, the user can start viewing the desired content 3 by simply pressing the key 26 corresponding to the desired content 3. In other words, because the user can perform switching between contents by a single-action operation of pressing of the key 26, so-called zapping can be smoothly performed.

Association between the content identification information 1c and the user operation 6b is automatically performed by the registered information storing section 15 when the user selects the content identification information 1c. As described above, in the case where the content identification information 1c is associated with any of the keys 26, for example, the content identification information lc may be assigned in order from the lowest number on the key 26.

In this example, an upper limit of the number of registrations is equivalent to the number of keys 26 (12 keys). Here, when the number of registration has reached the upper limit and the user attempts to perform further registration, the user may be notified that no more registrations can be performed. Alternatively, the oldest registered content may be deleted, and a thirteenth registration may be performed.

As other user operations 6b, for example, a motion camera that captures user movement (not illustrated in FIG. 1) may be included in the display device 100. The corresponding registered information 2 may be determined by identification of the direction in which the user lifts his or her arm. Alternatively, an acceleration sensor may be attached to the remote control 21. The corresponding registered information 2 may be determined by identification of the direction and speed at which the remote control 21 is swung.

In other words, any operation is possible as long as the operation allows unambiguous determination of the registered information 2 associated with the operation by the user. In particular, the user operation is preferably simple to an extent that the user can perform input with a single movement.

[Information Included in Registered Information 2]

An example of the information included in the registered information 2 will be described with reference to FIG. 5. FIG. 5 is a conceptual diagram expressing the details of the registered information 2 in table format. The rows in the table correspond with respective registered information 2. The columns indicate, in order from the first column, an ID number assigned to the registered information 2, details of the content identification information 1c, the user operation associated with the content identification information 1c, an end date and time (date and time specified by deadline information), and a repeat flag (acquisition information indicating whether or not a series of contents related to the content can be acquired at a predetermined time interval).

The end date and time indicated in the fourth column is the date and time at which provision of the content 3 identified by the content identification information 1c ends. For example, in the case where the content 3 is a television program, the end date and time is the date and time at which broadcasting of the program ends. The repeat flag indicated in the fifth column is a flag that indicates whether or not the content 3 identified by the content identification information 1c can be acquired at a predetermined time interval. For example, the repeat flag is set in the case where the content 3 is a television program (such as a serial drama) that is broadcast every other week.

In the case where the content 3 is a television program, information equivalent to the date and time at which broadcasting ends and the repeat flag is ordinarily included in the content identification information 1c. Therefore, in most instances, the information processing device 11 (registered information storing section 15) is not required to separately acquire the information from an external information source. However, for example, these pieces of information may be acquired over the Internet or the like.

The ID number in the first column is merely added for convenience of data management in the storage section 60 and is not necessary. In addition, usage example of the end date and time in the fourth column and the repeat flag in the fifth column will be described in a second embodiment. However, these pieces of information are not requisite information in the present embodiment.

[Display Examples of Registered Content Table 8]

The registered content table refers to a table in which the content identification information 1c included in the registered information 2 is arrayed in accordance with a predetermined format. The predetermined format may be a format in which the content identification information 1c is arrayed in a vertical direction or a horizontal direction of the display section 80 as described below, for example.

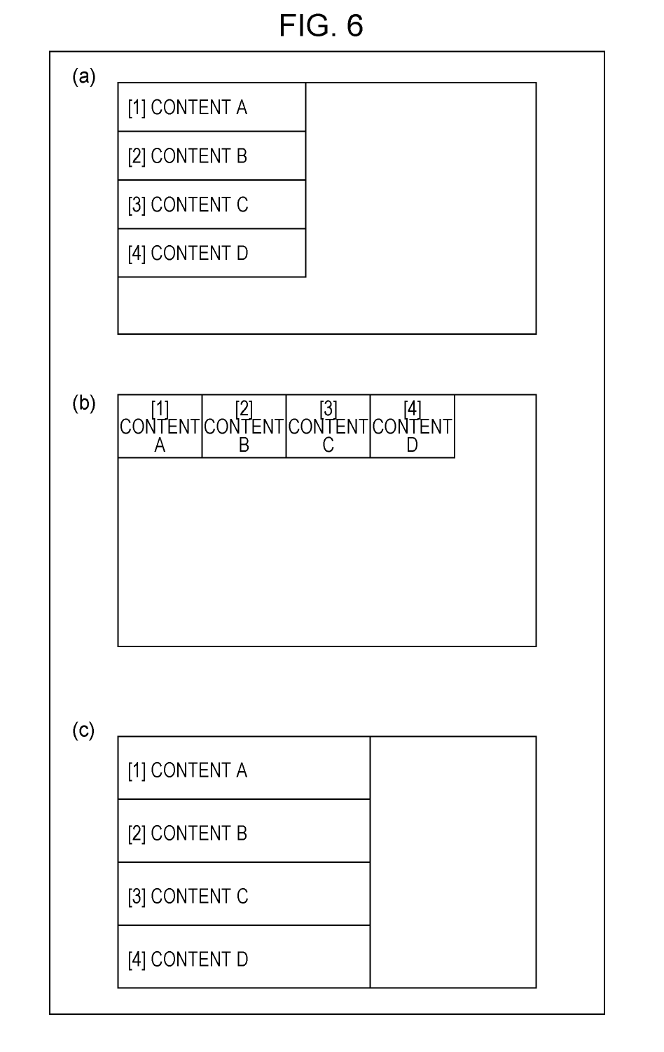

Display examples of the registered content table 8 will be described with reference to FIG. 6. FIG. 6 illustrates examples of the display format of the registered content table 8, in which (a) illustrates an example in which the registered content table 8 is structured in a format in which the registered information 2 is vertically arrayed, (b) illustrates an example in which the registered content table 8 is structured in a format in which the registered information 2 is horizontally arrayed, and (c) illustrates an example in which the registered content table 8 illustrated as an example in above-described (a) is displayed in an enlarged state.

In the three display examples illustrated in FIG. 6, the corresponding user operation 6b is clearly indicated in the registered content table 8 (displayed as [1], [2] . . . at the head of the details of the content identification information). However, a clear indication such as that in the above-described examples is not a requisite since it is merely required that the user knows the association between the content identification information 1c and the user operation 6b. For example, in the case where the associated user operation 6b is assigned in order of placement of the content identification information 1c in the registered content table 8, the clear indication of the associated user operation 6b may be omitted.

The registered content table 8 has a smaller display area than, for example, the ordinary content table 7 generated using the EPG. In other words, as illustrated in FIG. 12, the content table 7 has a display area that is large enough to occupy a significant portion of the display screen. Therefore, when the content table 7 is displayed by being superimposed onto the content 3 being viewed, user viewing is significantly obstructed. Conversely, the registered content table 8 includes only the content identification information 1c registered by the user. Therefore, the display area is smaller than the display area of the content table 7. As a result, even when the registered content table 8 is displayed by being superimposed onto the content 3 being viewed, user viewing is not obstructed. In addition, as illustrated in FIG. 6 (c), the registered content table 8 fits within a single screen even when displayed in an enlarged state. As a result, the user can more easily view the registered content 3.

In addition, in a manner similar to the format of the content table 7 described above, the registered content table 8 may, for example, be formatted such that the content identification information 1c is associated with a value of a first field (such as broadcast time) and a value of a second field (such as broadcast station), and disposed in an position at which a row showing the value of the first field and a column showing the value of the second field intersect.

The content identification information 1c included in the registered information 2 may, for example, be displayed in the order of registration. Alternatively, the content identification information 1c may be displayed based on the user operation 6b associated in the registered information 2 (such as in ascending order or descending order). In other words, the information may be displayed in any format and in any order as long as the format allows the user to easily view only information related to the registered content.

In addition, the display device 100 may be capable of switching display between the content table 7 and the registered content table 8. As a result, the user can easily view all the contents and the content desired by the user.

[Processes Performed by Display Device 100]

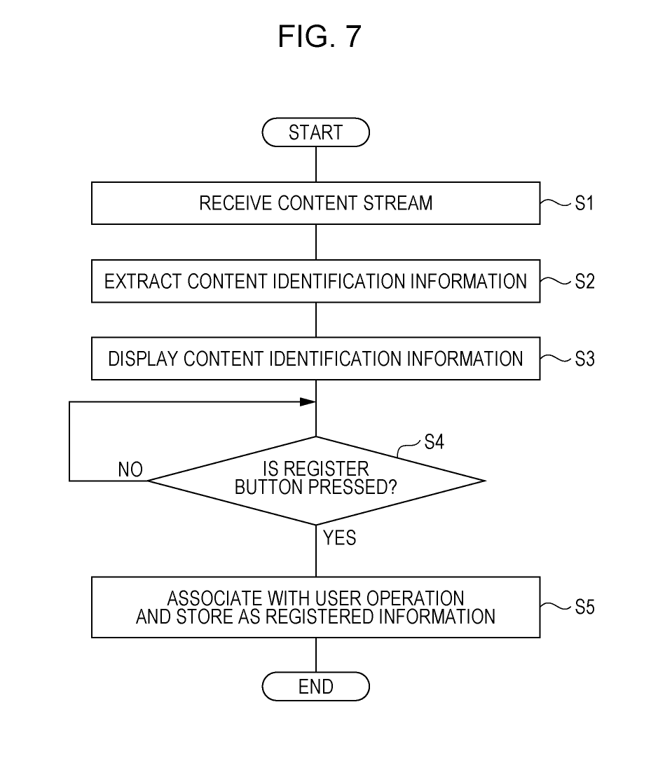

A flow of a process performed by the display device 100 will be described with reference to FIG. 7. FIG. 7 is a flowchart describing an example of a process performed by the display device 100 when the user presses the key 24 (“register” button) of the remote control 21 in an instance in which the content table 7 is being displayed.

First, the receiving section 30 receives the content stream 5 from an external source (Step 1: abbreviated hereinafter as S1). The content identification information extracting section 41 extracts only the content identification information 1a from the received content stream 5 and outputs the content identification information 1a to the content identification information selecting section 14 (S2).

The content identification information selecting section 14 displays the content identification information 1a by generating the content table 7 or the like (S3). The information processing device 11 detects the user operation 6a, and the content identification information selecting section 14 judges whether or not the user operation 6a is pressing of the key 24 (S4; selecting step). When judged that the user operation 6a is pressing of the key 24 (YES at S4), the content identification information selecting section 14 outputs the content identification information 1c selected by the user to the registered information storing section 15. The registered information storing section 15 associates the content identification information 1c with a predetermined user operation 6b and stores the associated content identification information 1c and user operation 6b in the storage section 60 as the registered information 2 (S5; storing step). On the other hand, when judged by the content identification information selecting section 14 that the key 24 is not pressed (NO at S4), the content identification information selecting section 14 continues to wait for the key 24 to be detected.

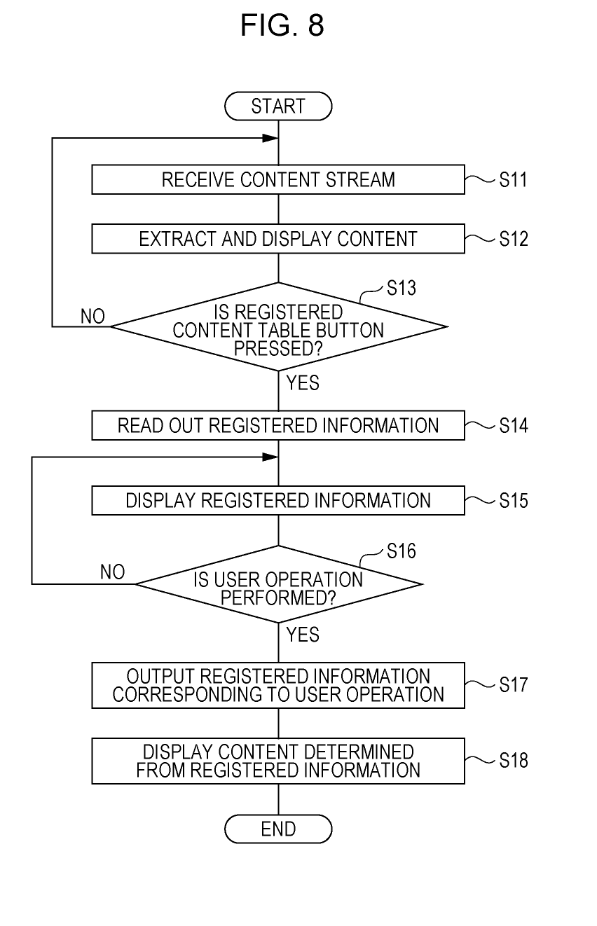

A flow of a process performed by the display device 100 will be described with reference to FIG. 8. FIG. 8 is a flowchart describing an example of a process performed by the display device 100 when the user presses the key 22 (“registered content table” button) of the remote control 21 in an instance in which the content 3 is being viewed (see FIG. 3).

First, the receiving section 30 receives the content stream 5 from an external source (S11). The content extracting section 50 extracts only the content 3 from the content stream 5 received by the receiving section 30 and outputs the content 3 to the display control section 70, thereby displaying the content 3 (S12).

The information processing device 11 detects the user operation 6a, and the registered information presenting section 16 judges whether or not the user operation 6a is pressing of the key 22 (S13). When judged that the user operation 6a is pressing of the key 22 (YES at S13), the registered information presenting section 16 reads out the registered information 2 stored in the storage section 60 (S14). The registered information presenting section 16 generates the registered content table 8 from the content identification information 1c included in the registered information 2 and outputs the registered content table 8 to the display control section 70, thereby displaying the registered content table 8 (S15).

It should be noted that read-out (S14) and display (S15) are required to be repeatedly performed for all or some of the pieces of registered information 2 stored in the storage section 60. When the information processing device 11 does not detect the user operation 6a (NO at S13), the display device 100 continues displaying the content 3.

The information processing device 11 waits for detection of the user operation 6b. When the user operation 6b is detected (YES at S16), the registered information output section 17 outputs the content identification information 1c associated with the user operation 6b to the display control section 70 (S17; output step). The display control section 70 that has received the input of the content identification information 1c displays the content 3 identified from the content identification information 1c in the display section 80 (S18).

[Effects Achieved by Information Processing Device 11]

The information processing device 11 receives registration from the user in units of contents and associates each content identification information identifying the content registered by the user with a predetermined operation, thereby achieving an effect of enabling the content identification information selected by the user to be determined. Therefore, even when numerous contents are provided, the information processing device 11 achieves the effect of enabling the user to view only the desired content, and enabling the desired content to be quickly selected.

### Second Embodiment

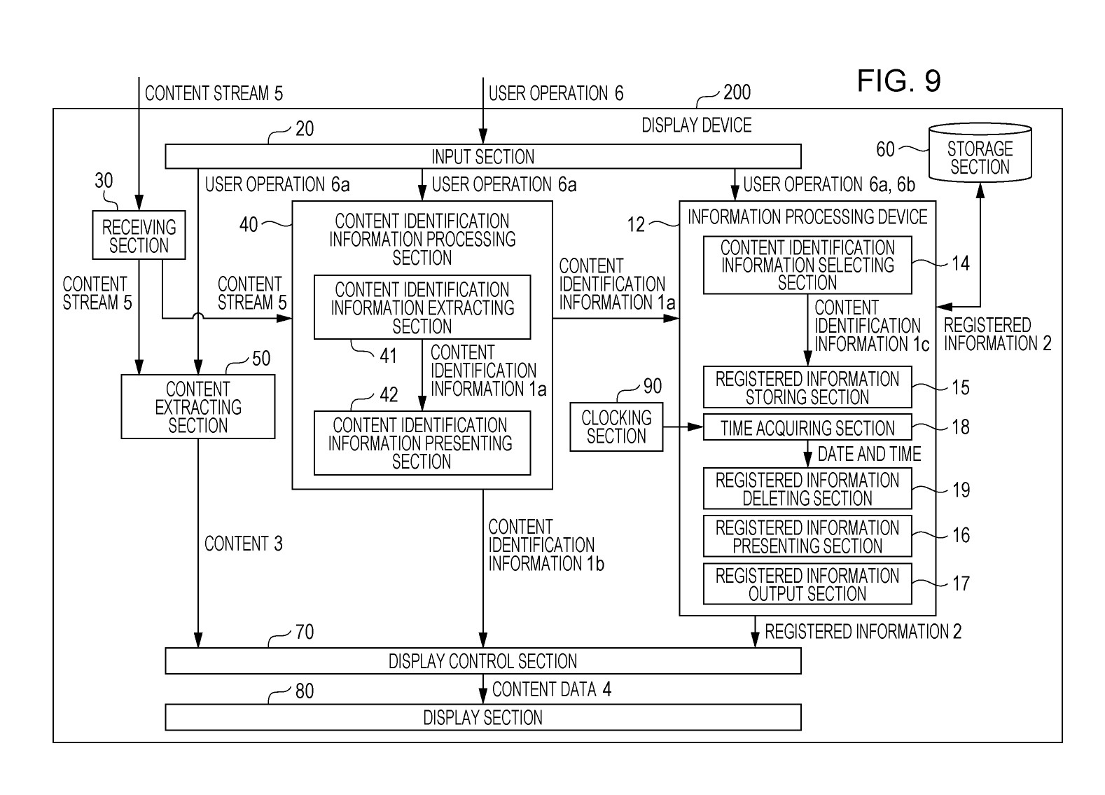

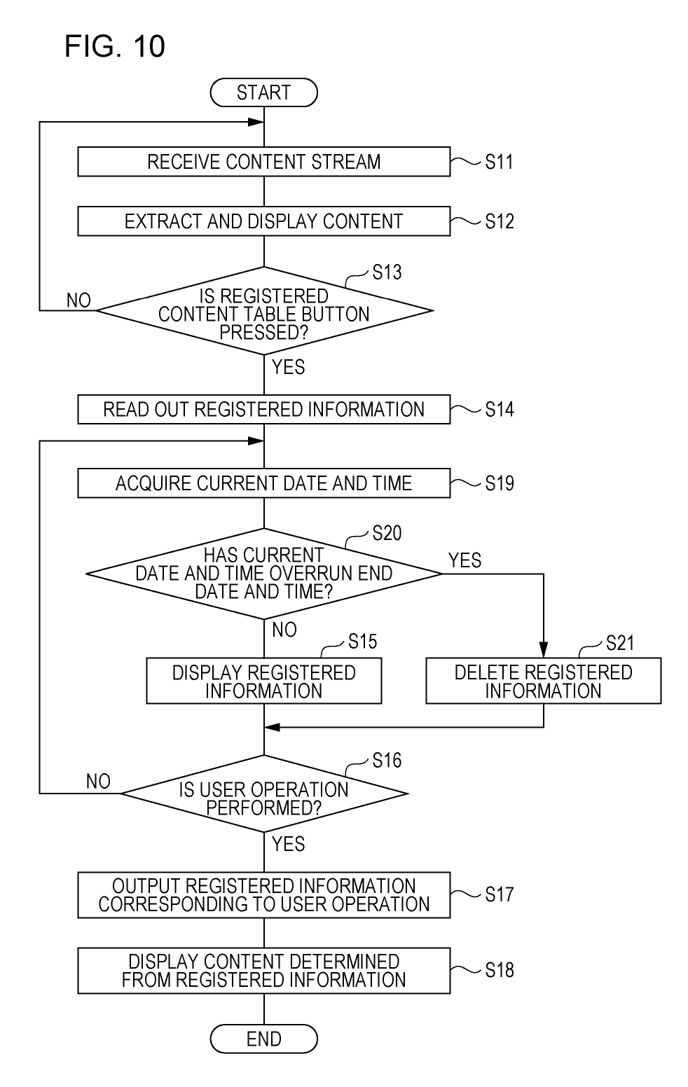

A second embodiment of the present invention will be described in detail with reference to FIG. 9 and FIG. 10. According to the present embodiment, a display device 200 is assumed as a display device that includes therein an information processing device 12. In addition, only configurations that have been added to the above-described first embodiment will be described hereafter. In other words, the configurations and the like described in the first embodiment are also included in the second embodiment. Furthermore, the definitions of terms described in the first embodiment are the same.

[Overview of Information Processing Device 12]

When provision of the content 3 corresponding with the registered information 2 ends, the registered information 2 becomes unnecessary. Therefore, the information processing device 12 according to the present embodiment compares current date and time with the end date and time included in the registered information 2. When judged that the current date and time is beyond the end date and time, the information processing device 12 deletes the registered information 2 from the storage section 60 and cancels the association with the user operation 6b.

[Configuration of Display Device 200]

A configuration of the display device 200 according to the present embodiment will be described with reference to FIG. 9. FIG. 9 is a block diagram of a configuration of main sections of the display device 200. As illustrated in FIG. 9, the display device 200 includes the information processing device 12, the input section 20, the receiving section 30, the content identification information processing section 40, the content extracting section 50, the storage section 60, the display control section 70, the display section 80, and a clocking section 90.

The information processing device 12 includes, in a manner similar to the information processing device 11 described in the first embodiment, the content identification information selecting section (selecting means) 14, the registered information storing section (storing means) 15, the registered information presenting section (presenting means) 16, and the registered information output section (output means) 17. The information processing device 12 further includes a time acquiring section (acquiring means) 18 and a registered information deleting section (deleting mean) 19. The content identification information processing section 40 includes the content identification information extracting section 41 and the content identification information presenting section 42 in a manner similar to the first embodiment.

In a manner similar to that described above, sections that are not directly related to the present embodiment are omitted from the description of the configuration and the block diagram. In addition, configurations that are the same as those included in the above-described display device 100 are given the same reference characters, and descriptions thereof are thereby omitted. Therefore, only the functions provided by the time acquiring section 18, the registered information deleting section 19, and the clocking section 90 will be described.

The clocking section 90 is a device for measuring the current date and time, and may be a common clock.

The time acquiring section 18 acquires the date and time measured by the clocking section 90, and outputs the date and time to the registered information deleting section 19.

The registered information deleting section 19 judges whether or not the current date and time acquired by the time acquiring section 18 is beyond the end date and time included in the registered information 2. When judged that the current date and time is beyond the end date and time, the registered information deleting section 19 deletes the registered information 2 from the storage section 60.

[Deletion of Repeatedly Provided Content]

When the repeat flag is set for the registered information to be deleted by the registered information deleting section 19 (in other words, when a series of contents related to the content can be acquired at a predetermined time interval), following issues may be considered. For example, the content 3 is a serial drama program that is broadcast every week. For example, in the case where the content 3 is broadcast on August 1, the registered information deleting section 19 deletes the registered information 2 corresponding to the content upon end of the broadcast. However, as a result, the user cannot select the broadcast in the following week (August 8) from the registered content table 8. It is inconvenient for the user to re-register a weekly broadcast.

In the above-described instance, for example, the registered information deleting section 19 might not actually delete the registered information 2. Rather, the registered information 2 may be saved in another storage section (not illustrated in FIG. 9) that is not subjected to read-out by the registered information presenting section 16. The registered information 2 may then be returned to the storage section 60 at a predetermined timing before the next broadcast. As a result, the registered information presenting section 16 does not present the information to the user as the registered information 2 after the content 3 has ended, and can re-present the information the next time the content 3 is provided.

Alternatively, the above-described issue may be handled by the registered information deleting section 19 setting a delete flag for the registered information 2 (not illustrated in FIG. 5) and by the registered information presenting section 16 not considering the registered information 2 of which the delete flag is set to be subjected to presentation to the user. Both of the above-described measures can be said to be equivalent to the deleted content identification information 1c being restored and stored again in the storage section 60.

Restoration of the deleted content identification information 1c may be performed at any time as long as it is before the series of content related to the content 3 identified by the content identification information 1c is provided. For example, the restoration may be performed one hour before provision of the content is started, or at the same time provision is started.

[Processes Performed by Display Device 200]

A flow of a process performed by the display device 200 will be described with reference to FIG. 10. FIG. 10 is a flowchart describing an example of a process performed by the display device 200.

Here, a significant portion of the process performed by the display device 200 is the same as the process performed by the display device 100 described with reference to FIG. 8. The processes that are the same are given the same reference characters, and description thereof is thereby omitted. Therefore, only the processes performed by the time acquiring section 18 and the registered information deleting section 19 will be described hereafter (S19 to S21 in FIG. 10).

After the registered information presenting section 16 reads out the registered information 2 stored in the storage section 60 (S14), the time acquiring section 18 acquires the current time measured by the clocking section 90 (S19) and outputs the current time to the registered information deleting section 19. The registered information deleting section 19 judges whether or not the current date and time has overrun the end date and time included in the registered information 2 (S20). When judged that the end date and time has been overrun (YES at S20), the registered information deleting section 19 deletes the registered information 2 from the storage section 60. When judged that the end date and time has not been overrun (NO at S20), the registered information presenting section 16 generates the registered content table 8 from the content identification information 1c included in the registered information 2 and outputs the registered content table 8 to the display control section 70, thereby displaying the registered content table 8 (S15).

It should be noted that time acquisition (S19), judgment (S20), and display (S15) or deletion (S21) are required to be repeatedly performed for all or some of the pieces of registered information 2 stored in the storage section 60.

[Effects Achieved by Information Processing Device 12]

The information processing device 12 achieves effects of being capable of suppressing presentation to the user of content that is not required to be presented, and of not wasting storage area for storing unnecessary registered information.

### Third Embodiment

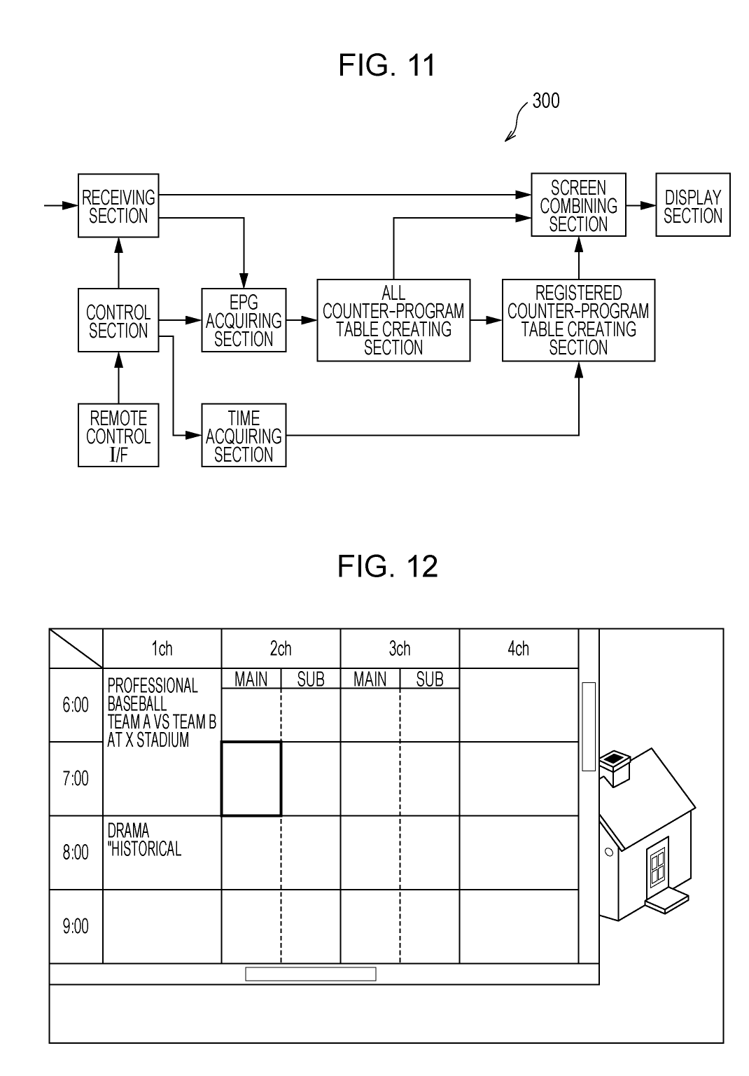

A third embodiment of the present invention will be described in detail with reference to FIG. 11. According to the present embodiment, a display device 300 is assumed that provides functions equivalent to the display device 100 including the information processing device 11 described in the first embodiment or the display device 200 including the information processing device 12 described in the second embodiment. In other words, the display device 300 according to the present embodiment is equivalent to a different implementation example of the display device 100 (information processing device 11) or the display device 200 (information processing device 12), and essential functions are unchanged.

A configuration of the display device 300 according to the present embodiment will be described with reference to FIG. 11. FIG. 11 is a block diagram illustrating a configuration of main sections of the display device 300 providing functions equivalent to the information processing device 11 or the information processing device 12. The display device 300 includes a receiving section (receiving section 30), a control section (display device), a remote control I/F section (input section 20), an EPG acquiring section (content identification information processing section 40 and content identification information extracting section 44), a time acquiring section (clocking section 90 and time acquiring section 18), an all counter-program table creating section (content identification information presenting section 42), a registered counter-program table creating section (content identification information selecting section 14, registered information storing section 16, registered information output section 17, and registered information deleting section 19), a screen combining section (display control section 70), and a display section (display section 80).

The EPG acquiring section extracts electronic program data (content identification information 1) that is superimposed onto digital broadcast (content stream 5). The time acquiring section extracts current time that is superimposed onto the digital broadcast. The all counter-program table creating section creates an all counter-program table (registered content table 8) from the electronic program table (content table 7) acquired by the EPG acquiring section.

The registered counter-program table creating section creates an electronic program table composed of only programs (content 3) selected by operation of a remote control (remote control 21) by the user, from the electronic program table acquired by the EPG acquiring section. The registered counter-program table creating section registers programs into the registered counter-program table and assigns a direct key (user operation 6b) on the remote control that corresponds with each program. In addition, the registered counter-program table creating section compares a broadcast end time of the program registered in the registered counter-program table with the current time acquired by the time acquiring section. When the current time has overrun the end time, the program is deleted from the registered counter-program table. Then, the registered counter-program table creating section cancels the assignation of the direct key.

The screen combining section combines (overlaps) the video data of the digital broadcast and the electronic program table created by the registered counter-program table creating section. The display section displays, on a screen, display data created by the screen combining section. The remote control I/F section receives user operation information of the remote control. The control section performs control of the creation and display of the all counter-program table and the creation and display of the registered counter-program table in accordance with remote control operation (pressing of keys 22 and 23) by the user.

[Combination of Configurations (Technical Means) Included in Embodiments]

It should be noted that the above-described configurations included in the first to third embodiments can be combined accordingly. In other words, all of the above-described configurations described in the first to third embodiments can be used such as to be combined in their entirety or in part, not only in the embodiment in which the respective configuration is described, but also in the other embodiments. Embodiments achieved as a result of the combination of configurations are also included in the technical scope of the present invention.

Furthermore, in other words, the present invention is not limited to the above-described embodiments. Various modifications are possible within the scope indicated by the claims. In other words, embodiments achieved by combination of technical means modified accordingly within the scope indicated by the claims are also included in the technical scope of the present invention.

[Examples of Implementation by Software]

Each block of the information processing device 11, the information processing device 12, the display device 100, the display device 200, and the display device 300 may be realized by hardware by a logic circuit formed on an integrated circuit (IC chip), or by software using a central processing unit (CPU).

In the latter instance, the information processing device 11, the information processing device 12, the display device 100, the display device 200, and the display device 300 each include a CPU that executes commands in a program for realizing each function, a read-only memory (ROM) that stores therein the above-described program, a random access memory (RAM) in which the above-described program is expanded, a storage device (recording medium) such as a memory that stores therein the above-described program and various pieces of data, and the like. The object of the present invention can also be achieved by the information processing device 11, the information processing device 12, the display device 100, the display device 200, and the display device 300 being provided with a recording medium storing therein, in a computer-readable format, program codes (executable format programs, intermediate code programs, and source programs) of control programs of the information processing device 11, the information processing device 12, the display device 100, the display device 200, and the display device 300 that are software realizing the above-described functions, and the computer (or CPU or MPU) reading out and executing the program codes stored in the recording medium.

As the above-described recording medium, for example, tapes such as magnetic tapes and cassette tapes, disks including magnetic disks such as Floppy® disks and hard disks, and optical disks such as CD-ROM, MO, MD, DVD, and CD-R, cards such as IC cards (including memory cards) and optical cards, semiconductor memories such as mask ROM, EPROM, EEPROM®, and flash ROM, and logical circuits such as programmable logic devices (PLD) and field programmable gate arrays (FPGA) can be used.

In addition, the information processing device 11, the information processing device 12, the display device 100, the display device 200, and the display device 300 can be configured such as to be capable of being connected to a communication network. The program codes may be provided over the communication network. The communication network is merely required to be capable of transmitting the program codes, and is not particularly limited. For example, the Internet, intranets, extranets, LAN, ISDN, VAN, CATV communication networks, virtual private networks, telephone networks, mobile communication networks, satellite communication networks, and the like can be used. In addition, the transmission medium configuring the communication network is merely required to be a medium capable of transmitting program codes, and is not limited to a specific configuration or type. For example, wired transmission media such as IEEE 1394, USB, power lines, cable TV lines, telephone lines, asymmetric digital subscriber lines (ADSL), and wireless transmission media such as infrared as in IrDA and remote controls, Bluetooth®, IEEE 802.11 wireless, high data rate (HDR), near field communication (NFC), digital living network alliance (DLNA), mobile phone networks, satellite channels, and terrestrial digital networks can be used. The present invention can also be realized in the form of computer data signals embedded in carrier waves in which the program codes are realized by electronic transmission.

In addition, in the above-described information processing device,

(1) the operation by the user can be inputted by the user with a single movement.

According to the above-described configuration, the operation performed by the user on the information processing device to select the registered content is completed by a single movement. Therefore, the user can successively designate the content identification information corresponding to a desired content by a single easy movement.

In addition, in the above-described information processing device,

(1) the single movement is pressing of a predetermined key provided in an input device capable of operating the information processing device.

According to the above-described configuration, the operation performed on the information processing device by the user when selecting a registered content is a very easy operation that is pressing a number button on a remote control. Therefore, the user can successively designate the content identification information corresponding to a desired content by a single easy movement.

The above-described pressing of a key might not be pressing of a physical button (hardware interface). For example, software keys may be displayed on a liquid crystal screen including a touch panel, and the content identification information may be designated by the user touching the software key.

In addition, in the information processing device,

(1) the content identification information further includes deadline information indicating a deadline until which content identified by the content identification information can be acquired, and

(2) an acquiring means for acquiring current date and time, and

(3) a deleting means for deleting, when the current date and time acquired by the acquiring means has overrun a date and time specified in the deadline information included in the content identification information, the content identification information from the storing section, are included.

According to the above-described configuration, the content identification information acquired by the information processing device from an external source includes deadline information indicating a deadline until which content identified by the content identification information can be acquired. Here, in the case where the content is a television program, for example, the deadline information is equivalent to the date and time at which the broadcast ends. In other word, the information processing device can identify the date and time at which the content can be acquired. On the other hand, because the information processing device can acquire the current date and time, the information processing device can judge whether or not the current date and time has overrun the date and time at which the content can be acquired. When judged that the date and time has been overrun, the content identification information corresponding to the content can be deleted from the storage section.

Therefore, content identification information corresponding to content that has been registered but has passed the deadline can be prevented from being presented to the user. In addition, as a result of unnecessary information being deleted, storage area in the storage section is not wasted.

In addition, in the information processing device,

(1) the content identification information further includes acquisition information indicating whether or not a series of contents related to the content identified by the content identification information can be acquired at a predetermined time interval, and

(2) the storing means, when judged from the acquisition information that the series of contents related to the content can be acquired at the predetermined time interval, restores the content identification information deleted by the deleting means and stores the content identification information again in the storage section.

According to the above-described configuration, the information processing device can judge whether or not a series of contents related to the content identified by the content identification information can be acquired at a predetermined time interval. For example, whether or not the content identified by the content identification information is a television program that is broadcast every other week (such as a serial drama) can be judged. When judged that the content can be acquired, the content identification information deleted from the storage section as a result of the deadline being exceeded can be restored and stored again in the storage section.

Therefore, the labor involved by the user having to register content every time a content in the series of contents is provided can be omitted.

In addition, the information processing device

(1) further includes a presenting means for presenting, to the user, the content identification information stored in the storage section by the storing means by outputting the content identification information to an external destination as a registered content table in which the content identification information is arrayed in accordance with a predetermined format.

According to the above-described configuration, the information processing device can present the user with a registered content table in which the content identification information is arrayed in accordance with a predetermined format. Here, it should be noted that the display area of the registered content table is smaller than that of an ordinary content table generated using, for example, EPG.

In other words, as illustrated as an example in FIG. 12, the content table is large enough to occupy a significant portion of the display screen. Therefore, when the content table is displayed by being superimposed onto content being viewed, user viewing is significantly obstructed. Conversely, the registered content table includes only the content identification information registered by the user. Therefore, the display area is smaller than that of the content table.

Therefore, even when the registered content table is displayed by being superimposed onto the content being viewed, user viewing is not obstructed. In addition, even when the registered content table is displayed in an enlarged state, the registered content table can be displayed within a single screen. Therefore, the user can more easily view the registered content.

In addition, the display device of the present invention

(1) displays content identified by the content identification information outputted from the information processing device in a display section.

According to the above-described configuration, the display device can receive the content identification information outputted from the information processing device as input and display the content corresponding to the content identification information. Therefore, even when numerous contents are provided, the user can view only the desired content and quickly select the desired content.

In addition, the display device

(1) displays a content table in which the content identification information is arrayed in accordance with a predetermined format.

According to the above-described configuration, because the display device can display the content table, the user can reference the content table. The content table includes a television program table generated using, for example, EPG.

In addition, the display device

(1) can perform display in which the content table and the registered content table can be switched.

According to the above-described configuration, the display device can perform display in which the content table and the registered content table can be switched. Therefore, the user can reference both the content table and the registered content table.

In addition, in the display device

(1) the registered content table is formed by the content identification information being arrayed in a vertical direction or a horizontal direction of the display section.

According to the above-described configuration, the content identification information corresponding to the content registered by the user is arrayed in the vertical direction or the horizontal direction in the display section of the display device, and is presented to the user as the registered content table. Therefore, the user can easily view the content identification information.

### INDUSTRIAL APPLICABILITY

The present invention can be suitably applied as a device included within or connected to a display device such as a television receiver that outputs content received from an external source to a display section.

### REFERENCE SIGNS LIST

1a content identification information
1b content identification information
1c content identification information
3 content
6a user operation
6b user operation (operation by user, pressing of predetermined key)
7 content table
8 registered content table
11 information processing device
12 information processing device
14 content identification information selecting section (selecting means)
15 registered information storing section (storing means)
16 registered information presenting section (presenting means)
17 registered information output section (output means)
18 time acquiring section (acquiring means)
19 registered information deleting section (deleting means)
21 remote control (operable input device)
60 storage section
80 display section
100 display device
200 display device
300 display device

1. An information processing device that outputs, in accordance with an operation by a user, content identification information including information that identifies content, the information processing device comprising:
a selecting section, configured to acquire the content identification information from an external source, and allow the user to select at least a single piece of content identification information from the content identification information;
a storing section, configured to associate the content identification information selected by the selecting section with the operation by the user, one to one, and configured to store the associated content identification information and operation by the user; and
an output section, configured to output, when the operation by the user is received, content identification information stored in the storage section in association with the received operation to an external destination.

2. The information processing device according to claim 1,
wherein the operation by the user can be inputted by the user with a single movement.

3. The information processing device according to claim 2,
wherein the single movement is pressing of a predetermined key provided in an input device capable of operating the information processing device.

4. An information processing device that outputs, in accordance with an operation by a user, content identification information including information that identifies content, the information processing device comprising:
a selecting section, configured to acquire the content identification information from an external source, and allow the user to select at least a single piece of content identification information from the content identification information;
a storing section, configured to associate the content identification information selected by the selecting section with the operation by the user, one to one, and configured to store the associated content identification information and operation by the user in a storage section;
an output section, configured to output when the operation by the user is received, content identification information stored in the storage section in association with the received operation to an external destination;
wherein the content identification information further includes deadline information indicating a deadline until which the content identified by the content identification information can be acquired;
wherein the information processing device further includes
an acquiring section, configured to acquire current date and time, and
a deleting section, configured to delete, when the current date and time acquired by the acquiring section has overrun a date and time specified in the deadline information included in the content identification information, the content identification information from the storage section.

5. The information processing device according to claim 4,
wherein the content identification information further includes acquisition information indicating whether or not a series of contents related to the content identified by the content identification information can be acquired at a predetermined time interval;
wherein the storing section, when judged from the acquisition information that the series of contents related to the content can be acquired at the predetermined time interval, is configured to restore the content identification information deleted by the deleting means section and store the content identification information again in the storage section.

6. The information processing device according to claim 1,
wherein the information processing device further includes a presenting section, configured to present, to the user, the content identification information stored in the storage section by outputting the content identification information to an external destination as a registered content table in which the content identification information is arrayed in accordance with a predetermined format.

7. A display device that displays the content identified by the content identification information outputted from the information processing device according to claim 1 in a display section.

8. A display device that displays the content identified by the content identification information outputted from the information processing device according to claim 6 in a display section.

9. The display device according to claim 8,
wherein a content table is displayed in which the content identification information is arrayed in accordance with a predetermined format.

10. The display device according to claim 9,
wherein the content table and the registered content table are switched and displayed.

11. The display device according to claim 8,
wherein the registered content table is formed by the content identification information being arrayed in a vertical direction or a horizontal direction of the display section.

12. A method for controlling an information processing device that outputs, in accordance with an operation by a user, content identification information including information that identifies content, the method comprising:
a selecting step of acquiring the content identification information from an external source, and allowing the user to select at least a single piece of content identification information from the content identification information;
a storing step of associating the content identification information selected at the selecting step with the operation by the user, one to one, and storing the associated content identification information and operation by the user in a storage section; and
an output step of outputting, when the operation by the user is received, content identification information stored in the storage section in association with the received operation to an external destination.

13. A control program for operating the information processing device according to claim 1,
wherein the control program allows a computer to function as each means.

14. A computer-readable recording medium storing therein the control program according to claim 13.
